(19) United States
(12) Patent Application Publication
(10) Pub. No.: US 2017/0058905 A1
(43) Pub. Date: Mar. 2, 2017

(54) FLUID DRIVING DEVICE, MOTOR ASSEMBLY AND CENTRIFUGAL FRICTION CLUTCH THEREOF

(71) Applicant: Johnson Electric S.A., Murten (CH)

(72) Inventors: Yue LI, Hong Kong (CN); Li Sheng LIU, Shen Zhen (CN); Yong WANG, Shen Zhen (CN); Ya Ming ZHANG, Shen Zhen (CN)

(21) Appl. No.: 15/255,864

(22) Filed: Sep. 2, 2016

(30) Foreign Application Priority Data
Sep. 2, 2015 (CN) 201510557326.9

(51) Int. Cl. F04D 25/06; H02K 17/04; H02K 7/108; F16D 43/18; F04D 29/28

(52) U.S. Cl. CPC F04D 25/06; F16D 43/18; F04D 29/282; H02K 7/108; H02K 17/04

(57) ABSTRACT

A centrifugal friction clutch is provided which includes a first friction member to be fixed on a rotary shaft; a support portion to be fixed on the rotary shaft; a centrifugal device disposed on the support portion, the centrifugal device including a cam portion and a centrifugal arm extending the cam portion, the cam portion being rotating relative to the support portion when the centrifugal arm moves; and a friction connecting member disposed between the first friction member and the support portion. When the support portion rotates along with the rotary shaft, a free end of the centrifugal arm moves radially outwardly under a centrifugal force and drives the cam portion to rotate, the cam portion urges the friction connecting member toward the first friction member when the cam portion rotates.

### CROSS REFERENCE TO RELATED APPLICATIONS

This non-provisional patent application claims priority under 35 U.S.C. §119(a) from Patent Application No. 201510557326.9 filed in The People's Republic of China on 2 Sep. 2015.

### FIELD OF THE INVENTION

This invention relates to the field of fluid driving devices, and in particular to a motor assembly for the fluid driving device, and a centrifugal friction clutch for the motor assembly.

### BACKGROUND OF THE INVENTION

In a fluid driving devices, such as a blower, a motor connects with an impeller to drive the impeller to rotation during operation. At startup of a single phase motor, the startup torque of the motor is small and fluctuates greatly. However, the impeller is stationary at its initial state, which requires the motor to have a large rotational inertia and startup load torque. As a result, vibrations may easily occur during startup of the motor; or even worse, motor startup failure may occur.

In a typical method of starting the single phase motor under load, a friction startup device is used to firstly drive the motor to rotate, which in turn progressively drives the impeller to rotate. Currently, the friction startup device consists of arcuate plates and an annular spring. Multiple arcuate plates are disposed on the impeller and are located on the same circle. The annular spring surrounds outer sides of the multiple arcuate plates. An end portion of a rotary shaft of the motor extends into a hole cooperatively defined by the multiple arcuate plates. As the rotary shaft of the motor rotates, the annular spring applies a constraint force to the multiple arcuate plates so that a friction force is generated between the arcuate plates and the rotary shaft. However, the friction force generated in this construction changes little with the change of the rotational speed, which is adverse to adjusting of the rotational inertia and the startup load torque at different rotational speeds and hence cannot effectively address vibrations and startup failure during the motor startup.

Therefore, it is urgently desired to reduce the rotational inertia and startup load applied to the rotary shaft during the motor startup and reduce the vibrational noises and the damage caused by motor startup failure.

### SUMMARY OF THE INVENTION

Thus, there is a desire for a centrifugal friction clutch for reducing the rotational inertia and startup load applied to the rotary shaft and reducing the vibrational noises and the damage caused by motor startup failure. There is also a desire for a motor assembly and a blower employing the above centrifugal friction clutch.

A centrifugal friction clutch is provided which includes a first friction member to be fixed on a rotary shaft; a support portion to be fixed on the rotary shaft; a centrifugal device disposed on the support portion, the centrifugal device including a cam portion and a centrifugal arm extending the cam portion, the cam portion being rotating relative to the support portion when the centrifugal arm moves; and a friction connecting member disposed between the first friction member and the support portion. When the support portion rotates along with the rotary shaft, a free end of the centrifugal arm moves radially outwardly under a centrifugal force and drives the cam portion to rotate, the cam portion urges the friction connecting member toward the first friction member when the cam portion rotates.

Preferably, in the centrifugal friction clutch, the friction connecting member includes a second friction member connected thereto, and the second friction member is configured to abut against the cam portion.

Preferably, in the centrifugal friction clutch, the centrifugal friction clutch further includes an elastic member for applying a pulling force to the centrifugal arm to move the centrifugal arm toward a central axis of the support portion.

Preferably, in the centrifugal friction clutch, there is a plurality of the centrifugal devices arranged on the support portion.

Preferably, in the centrifugal friction clutch, the elastic member is an elastic ring attached around a radially outer side of the centrifugal arm.

Preferably, in the centrifugal friction clutch, the radially outer side of the centrifugal arm forms a receiving slot, and the elastic member is received in the receiving slot.

Preferably, in the centrifugal friction clutch, the centrifugal friction clutch further includes a loading connecting member fixedly connected relative to the friction connecting member.

In another aspect, a motor assembly is provided which includes a single phase synchronous motor. The motor assembly further includes a centrifugal friction clutch in accordance with any of the above centrifugal friction clutches.

In another aspect, a fluid driving device is provided which includes an impeller and a motor assembly. The motor assembly is one in accordance with any of the above motor assemblies. Preferably, the fluid driving device is a blower.

Preferably, the motor assembly further comprises a position-limiting member disposed on the rotary shaft of the motor to limit axial movement of the impeller, and the position-limiting member is disposed at one side of the centrifugal friction clutch opposite from a main body of the motor.

### BRIEF DESCRIPTION OF THE DRAWINGS

In order to more clearly describe the technical solutions in the prior art or the embodiments of the present invention, the accompanying drawings to be used in the descriptions of the prior art or the embodiments are briefly introduced as follows. Obviously, the following accompanying drawings just illustrate some embodiments of the present invention, and people skilled in the art can obtain other drawings from these drawings without paying creative efforts.

FIG. 1 is a sectional view of a blower according to one embodiment of the present invention.

FIG. 2 illustrates an interior of a centrifugal friction clutch of one embodiment of the present invention.

FIG. 3 is an assembled view of a support portion, a centrifugal device and an elastic member of one embodiment of the present invention.

FIG. 4 is an exploded view of the support portion, a support shaft and the centrifugal device of the embodiment of the present invention.

FIG. 5 illustrates a motor assembly according to one embodiment of the present invention.

FIG. 6 illustrates a blower according to one embodiment of the present invention.

### DETAILED DESCRIPTION OF THE PREFERRED EMBODIMENTS

The present invention discloses a centrifugal friction clutch which reduces the rotational inertia and startup load applied to the rotary shaft, reduces the vibrational noises and avoids the damage caused by motor startup failure. The present invention further discloses a motor assembly and a blower employing the above centrifugal friction clutch.

The technical solutions of the embodiments of the present invention will be clearly and completely described as follows with reference to the accompanying drawings. Apparently, the embodiments as described below are merely part of, rather than all, embodiments of the present invention. Based on the embodiments of the present disclosure, any other embodiment obtained by a person skilled in the art without paying any creative effort shall fall within the protection scope of the present invention.

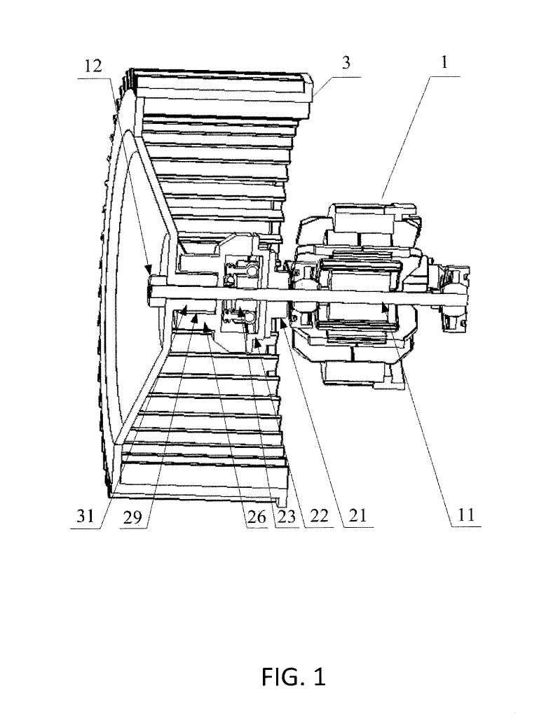

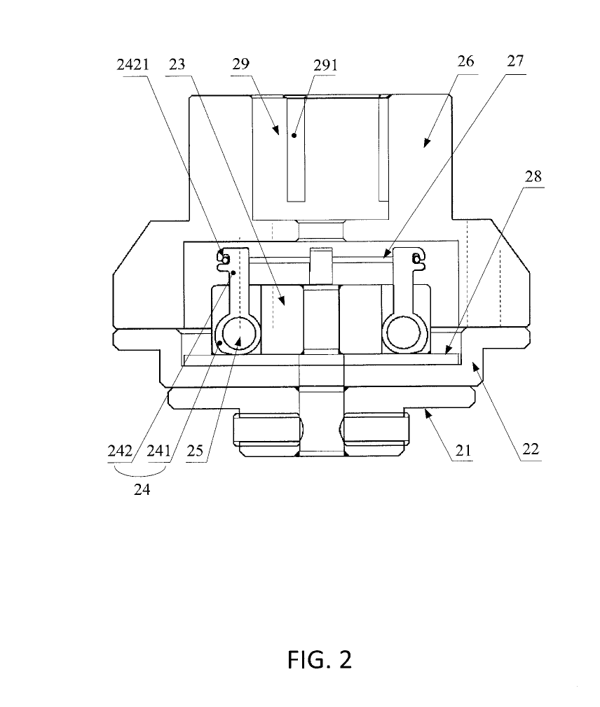

FIG. 1 is a sectional view of a blower in accordance with one embodiment of the present invention. FIG. 2 illustrates an interior of a centrifugal friction clutch of one embodiment of the present invention.

The centrifugal friction clutch in accordance with the embodiment of the present invention includes a first friction member 21, a friction connecting member 22, a support portion 23, a centrifugal device 24 and a support shaft 25.

The first friction member 21 and the support portion 23 are fixed on the rotary shaft 11 of the motor 1. The centrifugal device 24 includes a cam portion 241 and a centrifugal arm 242 fixedly connected with the cam portion 241. The cam portion 241 is hinged to the support portion 23 through the support shaft 25, such that the cam portion 241 is capable of rotating about an axis of the support shaft 25. A highest point of the cam portion 241 corresponds to a location of an outer surface of the cam portion 241 that is spaced from an axis of rotation of the cam portion by a maximal distance. At an initial state, the highest point of the cam portion 241 is located at one side of the axis of the support shaft 25 away from a center of the support portion 23. The friction connecting member 22 is disposed between the first friction member 21 and the support portion 23. Through this configuration, when the support portion 241 rotates along with the rotary shaft, a free end of the centrifugal arm 242 of the centrifugal device 24 moves radially and outwardly under a centrifugal force and, at the same time, drives the cam portion 241 to rotate. When rotating, the cam portion 241 urges the friction connecting member 22 toward the first friction member. The friction connecting member 22 is a connecting member that is directly or indirectly fixedly connected with the impeller 3. Alternatively, the friction connecting member 22 and the impeller 3 are formed into an integral structure, or the friction connecting member 22 acts directly as the impeller 3, in which case only a circumferential positioning between the friction connecting member 22 and the impeller 3 needs to be ensured.

In the centrifugal friction clutch of the embodiment of the present invention, at startup of the motor 1, the first friction member 21 and the support portion 23 rotate along with the rotary shaft 11. When the rotational speed of the rotary shaft 11 is low, the free end of the centrifugal arm 242 of the centrifugal device 24 experiences a small radial outward displacement because the free end is subject to a small centrifugal force, such that the cam portion 241 rotates a small angle relative to the support portion 23. Therefore, the urging force of the cam portion 241 applied to the friction connecting member 22 is small and, accordingly, the pressing force between the friction connecting member 22 and the first friction member 21 is small, such that a small frictional force is generated between the friction connecting member 22 and the first friction member 21. In addition, the impeller 3 and the friction connecting member 22 are connected and circumferentially positioned relative to teach other, such that the friction connecting member 22 slides relative to the first friction member 21 (and the rotary shaft 11). As the rotational speed of the rotary shaft 11 increases, the centrifugal force applied to the centrifugal arm 242 of the centrifugal device 24 significantly increases, and the radial outward displacement of the centrifugal arm 242 increases under the centrifugal force, which drives the cam portion 241 to rotate about the support shaft 25 at the same time. Because the highest point of the cam portion 241 is located at one side of the axis of the support shaft 25 away from the center of the support portion 23, the rotation of the cam portion 241 causes the highest point of the cam portion 241 moves toward the friction connecting member 22, thus progressively increasing the urging to the friction connecting member 22 and hence increasing the pressing force of the cam portion 241 applied to the friction connecting member 22. In addition, the pressing force is transmitted from the friction connecting member 22 to the first friction member 21, which effectively increases the frictional force between the friction connecting member 22 and the first friction member 21. As the rotational speed of the motor 1 increases, the pressing force that the cam portion 241 applies to the friction connecting member 22 progressively increases, and the frictional force between the friction connecting member 22 and the first friction member 21 also progressively increases. When the frictional force becomes large enough so that the friction connecting member 22 is driven by the first friction member 21 to rotate synchronously, i.e. the impeller 3 and the first friction member 21 become stationary relative to each other, the rotary shaft 11 drives the loading wheel 26 to rotate at the same speed. By means of the above configuration, the frictional force between the friction connecting member 22 and the first friction member 21 is small at startup of the motor 1 (the rotational speed of the rotary shaft 11 is low). Because the impeller 3 is stationary at the startup of the motor 1, the first friction member 21 and the friction connecting member 22 form a sliding friction pair. Because the impeller 3 and the friction connecting member 22 are connected and circumferentially positioned relative to each other, a relative sliding movement takes place between the first friction member 21 and the impeller 3. As the rotational speed of the rotary shaft 11 of the motor 1 increases, the highest point of the cam portion 241 moves in a direction toward the friction connecting member 22, thus progressively increasing the frictional force between the friction connecting member 22 and the first friction member 21. The amount of relative sliding movement between the first friction member 21 and the impeller 3 decreases until the first friction member 21 and the impeller 3 become stationary relative to each other, thereby achieving the progressive increase of the rotational speed of the impeller 3. In the centrifugal friction clutch of the embodiment of the present invention, the cam portion 241 of the centrifugal device 24 applies the pressing force to the friction connecting member 22, and this pressing force is proportional to the centrifugal force of the centrifugal arm 242. Therefore, the frictional force between the friction connecting member 22 and the first friction member 21 is proportional to a square of the rotational speed of the rotary shaft 11. When at low speed (startup of the motor 1), the friction connecting member 22 and the first friction member 21 slide relative to each other, such that the impeller 3 and the first friction member 21 slide relative to each other, which reduces the rotational inertia and startup load torque applied to the rotary shaft 11, reduces the vibration noises at startup of the motor 1, and avoids the startup failure of the motor 1.

In order to increase the frictional force applied to the friction connecting member 22, the friction connecting member 22 of the centrifugal friction clutch of the embodiment of the present invention includes a second friction member 28 fixed thereto. The cam portion 241 and the second friction member 28 directly contact with each other. As the cam portion 241 rotates, the frictional force between the second friction member 28 and the friction connecting member 22 steadily increases, thus increasing the frictional force applied to the friction connecting member 22.

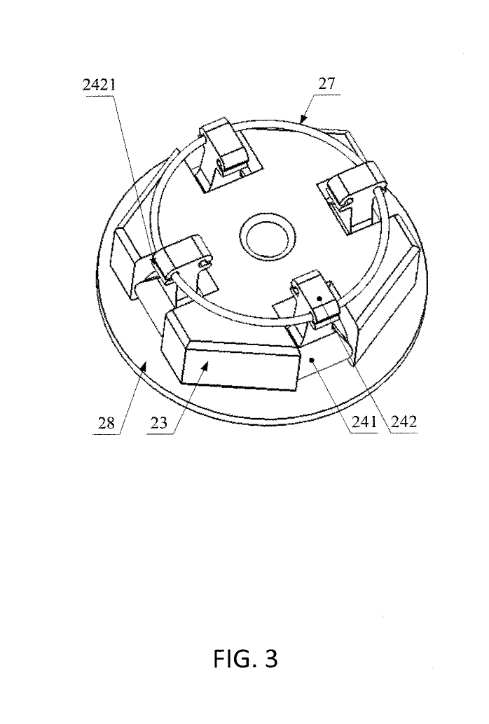

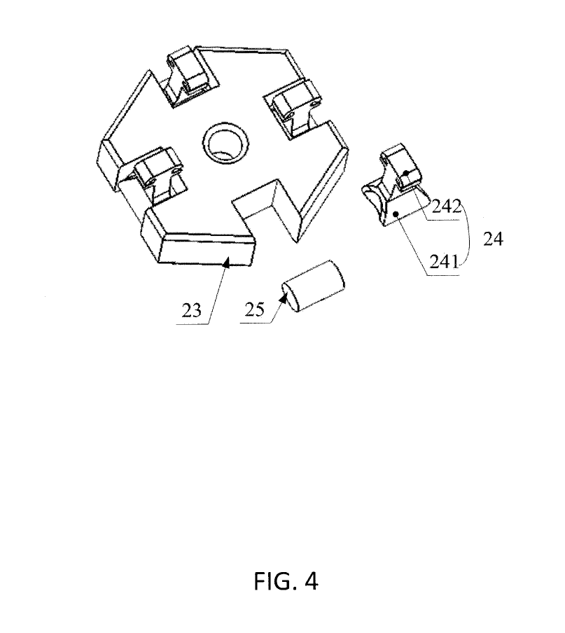

As shown in FIG. 2, FIG. 3, and FIG. 4, the centrifugal friction clutch further includes an elastic member 27 for applying a pulling force to the centrifugal arm 242 to make the centrifugal arm 242 move toward a central axis of the support portion 23. By means of the elastic member 27, when the rotary shaft 11 stops rotating, the centrifugal device may return to its original position.

In this embodiment, there is a plurality of the centrifugal devices 24 uniformly arranged on the support portion 23. By means of the above configuration, multiple centrifugal devices 24 uniformly apply the pressing force to the friction connecting member 22, which increases the uniformity of the distribution of the force applied to the friction connecting member 22 and the first friction member 21. In this embodiment, the number of the centrifugal devices 24 is four, with two adjacent centrifugal devices 24 spaced circumferentially by an angle of 90°. Alternatively, the number of the centrifugal devices 24 can also be another value such as three, two, or more than five, which are not described herein one by one.

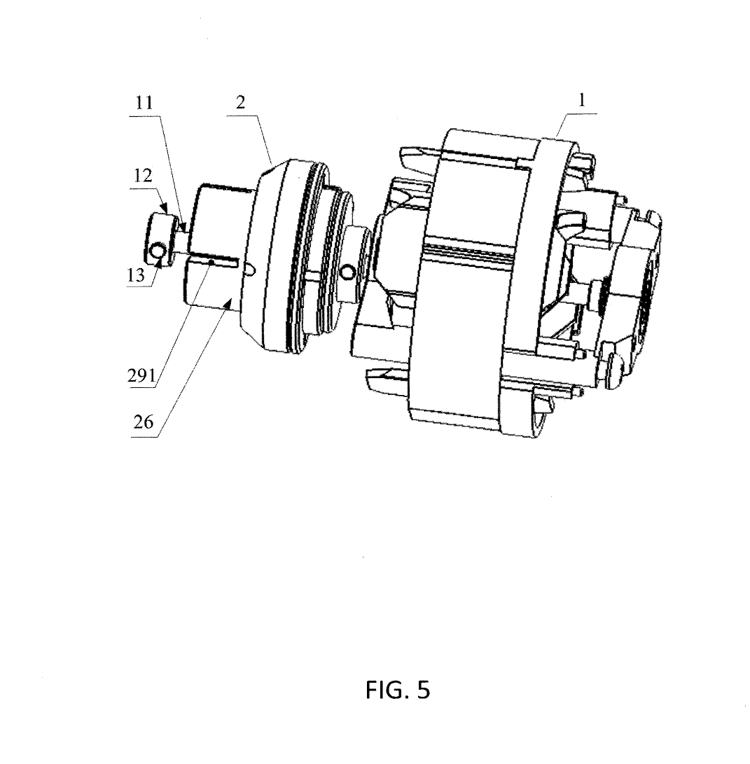

In another embodiment, a plurality of the elastic members 27 may be disposed in a one-to-one correspondence with the multiple centrifugal arms 242. If the elastic member 27 is a spring, one end of the spring is connected with the support portion 23, and the other end is connected with one corresponding centrifugal arm 242. In this embodiment, in order to simplify the structure, there is only one elastic member 27. As shown in FIG. 5, the elastic member 27 is an elastic ring attached around outer sides of the multiple centrifugal arms 242. Under the centrifugal force, the multiple centrifugal arms 242 stretch the elastic ring outwards. The elastic ring may be a metal spring ring, rubber ring or plastic ring with high elasticity, which are not described herein one by one.

A receiving slot 2421 is formed in the outer side of the centrifugal arm 242, and the elastic member 27 is received in the receiving slot 2421. The presence of the receiving slot 2421 effectively increases the stability of the connection between the elastic member 27 and the centrifugal arm 242 and prevents falling off of the elastic member 27.

The centrifugal friction clutch of the embodiment of the present invention further includes a loading wheel 26 fixedly connected with the friction connecting member 22. That is, in this embodiment, the friction connecting member 22 and the impeller 3 are indirectly fixed through the loading wheel 26.

Understandably, the friction connecting member 22 and the loading wheel 26 may be connected with bolts. When the cam portion 241 exerts the pressing force to the friction connecting member 22, the friction connecting member 22 moves in a direction away from the loading wheel 26. Alternatively, the friction connecting member 22 may also be made from a flexible plate to increase the frictional force between the friction connecting member 22 and the first friction member 21.

In order to ensure the circumferential positioning between the loading wheel 26 and the impeller 3, the loading wheel 26 is formed with latching grooves 27 for latching with the impeller 3. Alternatively, circumferential positioning between the loading wheel 26 and the impeller 3 may also be achieved by using bolts, pins, rivets or adhesive.

As shown in FIG. 1 and FIG. 2, in one embodiment, the load wheel 26 may be formed with a fixing hole 29, and the impeller 3 includes a protruding structure 31 inserted into the fixing hole 29. An inner wall of the fixing hole 29 is formed with the latching grooves 291, and an outer surface of the protruding structure 31 is formed with projections for engaging with the latching grooves 291.

As shown in FIG. 5, in another embodiment, the latching grooves 291 are formed in the outer surface of the loading wheel 26. In order for the impeller 3 to engage with the latching grooves 291 of the loading wheel 26, the impeller 3 includes a fixing hole (not shown), and an inner wall of the fixing hole is formed with projections for engaging with the latching grooves 291.

Alternatively, the loading wheel 26 and the impeller 3 may also be integrally formed.

One embodiment of the present invention further provides a motor assembly including a single phase motor 1 and a centrifugal friction clutch 2. The centrifugal friction clutch 2 is any one of the above-described centrifugal friction clutches. Since the above-described centrifugal friction clutches achieve the above-described technical results, the motor assembly employing the above-described centrifugal friction clutch can also achieve the same technical results, which are not described further herein one by one.

In order to facilitate the axial positioning of the impeller, the motor assembly in accordance with the embodiment of the present invention further includes a position-limiting member 12 disposed on the rotary shaft 11 of the motor 1 to limit axial movement of the impeller 3. The position-limiting member 12 is disposed at one side of the centrifugal friction clutch 2 opposite from a main body of the motor 1.

As shown in FIG. 5, the position-limiting member 12 is positioned on the rotary shaft 11 with a fastening screw 13. In an alternative embodiment, the position-limiting member 12 may also be configured to be a nut, and an end portion of the rotary shaft 11 is provided with threads for engaging with the nut. In still another embodiment, the position-limiting member 12 may be configured to be a clip spring, and the end portion of the rotary shaft 11 is provided with a latching groove for engaging with the clip spring. These embodiments all fall within the scope of the present invention, which are not described further herein one by one.

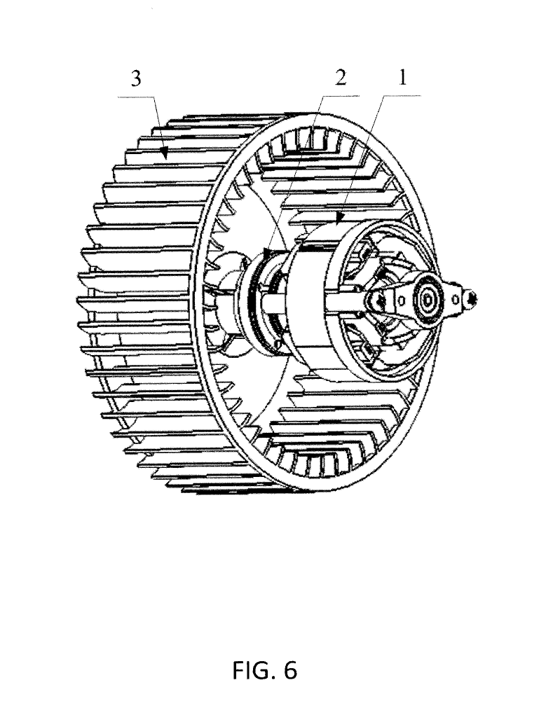

As shown in FIG. 6, one embodiment of the present invention further provides a blower including an impeller 3 and a motor assembly. The motor assembly is any one of the above-described motor assemblies. Since the above-described motor assemblies achieve the above-described technical results, the blower employing the above-described motor assembly can also achieve the same technical results, which are not described further herein one by one.

All embodiments in the specification are described in a progressive way, each embodiment mainly describes the differences from other embodiments, and the same and similar parts among the embodiments can be referenced mutually.

Although the invention is described with reference to one or more embodiments, the above description of the embodiments is used only to enable people skilled in the art to practice or use the invention. It should be appreciated by those skilled in the art that various modifications are possible without departing from the spirit or scope of the present invention. The embodiments illustrated herein should not be interpreted as limits to the present invention, and the scope of the invention is to be determined by reference to the claims that follow.

1. A centrifugal friction clutch comprising:
a first friction member to be fixed on a rotary shaft;
a support portion to be fixed on the rotary shaft;
a centrifugal device disposed on the support portion, the centrifugal device comprising a cam portion and a centrifugal arm extending from the cam portion, the cam portion being rotating relative to the support portion when the centrifugal aim moves; and
a friction connecting member disposed between the first friction member and the support portion, wherein when the support portion rotates along with the rotary shaft, a free end of the centrifugal arm moves radially outwardly under a centrifugal force and drives the cam portion to rotate, the cam portion urges the friction connecting member toward the first friction member when the cam portion rotates.

2. The centrifugal friction clutch of claim 1, wherein the friction connecting member comprises a second friction member connected thereto, and the second friction member is configured to abut against the cam portion.

3. The centrifugal friction clutch of claim 1, wherein the centrifugal friction clutch further comprises an elastic member for applying a pulling force to the centrifugal arm to move the centrifugal arm toward a central axis of the support portion.

4. The centrifugal friction clutch of claim 3, wherein there is a plurality of said centrifugal devices arranged on the support portion.

5. The centrifugal friction clutch of claim 3, wherein the elastic member is an elastic ring attached around a radially outer side of the centrifugal arm.

6. The centrifugal friction clutch of claim 5, wherein the radially outer side of the centrifugal arm forms a receiving slot, and the elastic member is received in the receiving slot.

7. The centrifugal friction clutch of claim 1, wherein the centrifugal friction clutch further includes a loading connecting member fixedly connected relative to the friction connecting member.

8. A motor assembly comprising a single phase motor and a centrifugal friction clutch according to claim 1.

9. A fluid driving device comprising an impeller and a motor assembly according to claim 8.

10. The fluid driving device of claim 9, wherein the motor assembly further comprises a position-limiting member disposed on the rotary shaft of the motor to limit axial movement of the impeller, and the position-limiting member is disposed at one side of the centrifugal friction clutch opposite from a main body of the motor.

11. The fluid driving device of claim 9, wherein the fluid driving device is a blower.
